(19) United States
(12) Patent Application Publication
(10) Pub. No.: US 2024/0207892 A1
(43) Pub. Date: Jun. 27, 2024

(54) METHOD OF CURING A WATERBORNE COATING

(71) Applicant: SWIMC LLC, Cleveland, OH (US)

(72) Inventors: Lars SANDQVIST, Hjältevad (SE); Claes WEDE, Hjältevad (SE); Rickard DROUGGE, Marsta (SE); Petter SANDSTRÖM, Jönköping (SE)

(21) Appl. No.: 18/555,108

(22) PCT Filed: May 3, 2022
(86) PCT No.: PCT/US2022/027369

§ 371 Date: Oct. 12, 2023

Related U.S. Application Data
(60) Provisional application No. 63/225,048, filed on Jul. 23, 2021.
(60) Provisional application No. 63/185,556, filed on May 7, 2021.

(51) Int. Cl. B05D 3/06; B05D 3/02; B05D 3/14; C09D 4/06; C09D 7/61; C09D 7/63

(52) U.S. Cl. CPC B05D 3/067; B05D 3/0263; B05D 3/147; C09D 4/06; C09D 7/61; C09D 7/63; B05D 2520/00

(57) ABSTRACT

Provided herein is a method of curing a waterborne coating comprising: (1) preparing a waterborne coating comprising: (a) at least one photoinitiator and (b) at least one pigment, wherein the pigment volume concentration of the waterborne coating is 2.0% to 68.7%; (2) curing the waterborne coating using UV radiation; and (3) curing the waterborne coating using EB. The method may further comprise the step of drying the waterborne coating prior to curing the waterborne coating using UV radiation. Also described is a waterborne coating prepared from the method described herein and an article to which the waterborne coating is applied.

### FIELD

The present disclosure relates generally to a method for curing a coating and, more particularly, a waterborne coating, comprising: (1) preparing a waterborne coating comprising: (a) at least one photoinitiator and (b) at least one pigment, wherein the pigment volume concentration of the waterborne coating is 2.0% to 68.7%; (2) curing the waterborne coating using UV radiation; and (3) curing the waterborne coating using EB radiation. The waterborne coating prepared from the method described herein and an article to which the waterborne coating is applied are also described.

### BACKGROUND

Conventionally, some coatings may be dried by both heat and ultraviolet (UV) radiation in order to enable handling and potential stacking soon after the coating process. For this process, convection heat drying may be followed by UV curing for these coatings, especially in pigmented waterborne UV formulations. These coatings may have a lack of scratch resistance or hardness needed to withstand handling, storage, and overall performance.

However, this process of UV radiation curing typically requires the addition of isocyanate hardener and photoinitiator(s) to generate post through-cure and adhesion. Isocyanates are undesirable since they are known to be hazardous materials. There may also be a limit to the level of pigments within coatings formulations in order to provide adequate curing using UV radiation. Suitable UV curing may be limited to coatings that are transparent or closer to transparent, and UV curing may not be able to penetrate completely through a thicker coating. Additionally, there may be drawbacks associated with handling of these products with a certain limited pot life.

Instead of using UV radiation curing, electron beam (EB) curing is performed under inert conditions to mitigate oxygen inhibition of the crosslinking reaction at the coating surface. This processing requires special curing requirements and equipment during manufacturing. Further, the use of EB curing may be costly due to the need for nitrogen inertization often used during production. Although no photoinitiator is typically used in EB curing, penetration in EB curing may be more uniform, especially with less dense coatings. Since EB curing is not affected by the amount of pigments, it can provide increased hiding power in the coatings formula.

In view of these challenges with conventional coatings curing methods, the need therefore remains for improved pigmentation, stackability, scratch resistance, hardness, adhesion and processing costs as well as other advantages. In addition to UV curing, the use of EB curing may provide the possibility to use more pigments in a coatings formulation. There is also a need for a method to prepare such coatings and articles with such coatings.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A method of curing a coating, including a waterborne coating is shown and described. The method of curing a waterborne coating comprising: (1) preparing a waterborne coating comprising: (a) at least one photoinitiator and (b) at least one pigment, wherein the pigment volume concentration of the waterborne coating is 2.0% to 68.7%; (2) curing the waterborne coating using UV radiation; and (3) curing the waterborne coating using EB.

The method may further comprise the step of drying the waterborne coating prior to curing the waterborne coating using UV radiation. Also provided herein is a waterborne coating prepared from the method described herein and an article to which the waterborne coating is applied.

To the accomplishment of the foregoing and related ends, the following description set forth certain illustrative aspects and implementations. These are indicative of but a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings systems, that provide advantageous improvements over current coatings. It has been discovered that the method of curing a waterborne coating by curing first using UV radiation and then curing using EB, where a waterborne coating comprises: (a) at least one photoinitiator and (b) at least one pigment, wherein the pigment volume concentration of the waterborne coating is 2.0% to 68.7%. This method of curing can surprisingly lead to improved performance properties, namely improved scratch resistance, hardness, stackability, adhesion, hiding power, color intensity, and lower gloss, as well as other advantages.

In one embodiment, a method of curing a waterborne coating is disclosed. The method of curing a waterborne coating may comprise: (1) preparing a waterborne coating comprising: (a) at least one photoinitiator and (b) at least one pigment, wherein the pigment volume concentration of the waterborne coating is 2.0% to 68.7%; (2) curing the waterborne coating using UV radiation; and (3) curing the waterborne coating using EB.

The waterborne coating may first be subjected to curing using UV radiation, which provides a source of energy for hardening and curing. UV radiation, as described herein, includes UV in the wavelength range of 100 nm to 420 nm. UV may include UV-A, UV-B, UV-C and UV-Visible (also referred to as UV-V). In many embodiments, the sources of UV radiation may include but are not limited to LED, medium pressure mercury lamps, low pressure mercury lamps, black lights, curing lamps, halogen lights, fluorescent and incandescent sources, and some types of lasers. UV radiation curing also provides a fast and efficient means for curing over many other methods of curing. After the curing using UV radiation, the waterborne coating may then be subjected to curing using EB. Electron beam may provide curing beyond the surface of the waterborne coating, regardless of the surface reflectivity or color of the waterborne coating.

In many embodiments, at least one photoinitiator comprises a surface curing type I photoinitiator, a type II photoinitiator, or combinations thereof. In some embodiments, the waterborne coating may comprise 0.1-10% of type I photoinitiator. In some embodiments, the waterborne coating may comprise 0.1-10% of type II photoinitiator. In many embodiments, at least one photoinitiator is used in curing the waterborne coating using UV radiation where it may be used to initialize the polymerization process. In many embodiments, at least one photoinitiator of the waterborne coating is 0.1% to 10%. In other embodiments, the photoinitiator concentration of the waterborne coating described herein can, for example, range from 0.1% to 9%, from 0.1% to 8%, from 0.5% to 10%, from 0.5% to 9%, from 0.5% to 8%, from 0.5% to 7%, from 1% to 10%, from 1% to 9%, from 1% to 8%, from 1% to 7%, from 1% to 6%, from 2% to 9%, from 2% to 8%, from 2% to 7%, from 2% to 6%, from 3% to 9%, from 3% to 8%, from 4% to 9%, from 4% to 8%, from 5% to 9%, from 5% to 8%, and from 6% to 9%.

Type I photoinitiators are characterized by a cleavage reaction into two radical fragments of the original photoinitiator. The irradiation with UV-light leads to a homolytic bondage cleavage and generation of two highly reactive radical species that initiate the polymerization. As a result, the type I photoinitiator is irreversibly incorporated into the polymer matrix. Unlike type I photoinitiators, type II photoinitiators, when irradiated by UV-light, need a hydrogen donor such as amines to react, forming two radicals. Type II photoinitiators normally are not incorporated during the reaction. In some embodiments, at least one type I photoinitiator comprises a hydroxy acetophenone or a phosphine oxide. In other embodiments, at least one type I photoinitiator comprises an alkylamino acetophenone, a benzil ketal, a benzoin ether, 1-phenyl-1,2-propanedione-2-(O-ethoxycarbonyl)oxime, [1-(4-phenylsulfanylbenzoyl)heptylideneamino]benzoate, [1-[9-ethyl-6-(2-methylbenzoyl)carbazol-3-yl]ethylideneamino] acetate, or combinations thereof. Other Type I photoinitiators are also contemplated.

In some embodiments, at least one type II photoinitiator comprises a benzophenone or methyl benzoylformate. In other embodiments, at least one type II photoinitiator comprises a thioxanthone, a keto-coumarin, a blend of oxy-phenyl-acetic acid 2-[2-oxo-2-phenyl-acetoxy-ethoxy]-ethyl ester and oxy-phenyl-acetic acid 2-[2-hydroxy-ethoxy]-ethyl, benzil, an anthraquinone, a polyethylene glycol di(β-4[4-(2-dimethylamino-2-benzyl) butaonylphenyl]piperazine)propionate ester, a fluorenone, or combinations thereof. Other type II photoinitiators are also contemplated.

In many embodiments, at least one pigment comprises an organic pigment, an inorganic oxide, or combinations thereof. In some embodiments, at least one pigment is an oxide. In one embodiment, at least one pigment is titanium dioxide. In one embodiment, at least one pigment is iron oxide. In one embodiment, at least one pigment is zinc oxide. In another embodiment, at least one pigment is carbon black. Other pigments are also contemplated.

In many embodiments, the pigment volume concentration of the waterborne coating is 2.0% to 68.7%. In other embodiments, the pigment volume concentration of the waterborne coating described herein can, for example, range from 2.4% to 60.0%, from 3.0% to 55.0%, from 3.5% to 53.0%, from 3.8% to 50.0%, from 4.0% to 50.0%, from 4.4% to 48.0%, from 4.7% to 47.0%, from 5.0% to 45.0%, and from 5.5% to 42.0%. In some embodiments, the pigment volume concentration of the waterborne coating may be at least 2.0%. In other embodiments, the pigment volume concentration of the waterborne coating described herein can, for example, be at least at least 2.3%, at least 2.4%, at least 2.7%, at least 3.0%, at least 3.2%, at least 3.5%, at least 3.7%, at least 3.9%, at least 4.0%, at least 4.4%, at least 4.7%, at least 5.0%, at least 5.3%, and at least 5.5%. Other ranges are also contemplated.

In many embodiments, the method of curing a waterborne coating described herein further comprises the step of drying the waterborne coating prior to curing the waterborne coating using UV radiation. In some embodiments, at least one heat source is used for drying the waterborne coating. In many embodiments, at least one heat source may include ovens, air dryers, or hybrid dryers. In some embodiments, infrared radiation is used for drying the waterborne coating. In one embodiment, the infrared radiation is provided by at least one infrared radiation battery. Other heat sources are contemplated.

In some embodiments, drying the waterborne coating is performed at temperatures ranging from 10° C. to 95° C. In other embodiments, drying the waterborne coating described herein can, for example, range in temperature from 10° C. to 90° C., from 15° C. to 90° C., from 15° C. to 85° C., from 20° C. to 90° C., from 20° C. to 85° C., from 25° C. to 85° C., from 25° C. to 80° C., from 25° C. to 75° C., from 25° C. to 70° C., from 25° C. to 65° C., from 30° C. to 90° C., from 30° C. to 80° C., from 30° C. to 75° C., from 30° C. to 70° C., from 30° C. to 65° C., from 30° C. to 60° C., and from 30° C. to 55° C. In other embodiments, drying the waterborne coating may performed at temperatures higher than 95° C. Temperatures lower than 10° C. are also contemplated.

In many embodiments, the waterborne coating further comprises acrylate functional water dispersed binder, defoamer, matting agent, wetting agent, filler, or combinations thereof. Other materials are also contemplated.

In many embodiments, the method of curing the waterborne coating described herein may minimize or eliminate the need for nitrogen during the EB curing process. In some embodiments, nitrogen addition is minimized during the curing of the waterborne coating using EB. The reduction or elimination of nitrogen may reduce costs in curing the waterborne coatings due to lower nitrogen consumption costs and less equipment needs.

In many embodiments, curing of the waterborne coating using EB is performed at temperatures ranging from −10° C. to 50° C. and a relative humidity ranging from 2% to 85%. In other embodiments, the curing of the waterborne coating described herein using EB can, for example, range in temperature from −5° C. to 45° C., from 0° C. to 40° C., from 5° C. to 40° C., from 10° C. to 40° C., from 10° C. to 35° C., from 10° C. to 30° C., from 10° C. to 25° C., and from 10° C. to 20° C. Other ranges are also contemplated. In other embodiments, the curing of the waterborne coating described herein using EB can, for example, range in relative humidity from 5% to 85%, from 10% to 85%, from 15% to 80%, from 15% to 75%, from 20% to 75%, from 20% to 70%, from 25% to 70%, from 25% to 65%, from 30% to 65%, from 30% to 60%, from 35% to 60%, from 35% to 55%, from 40% to 55%, and from 40% to 50%. Other ranges are also contemplated.

In many embodiments, a waterborne coating may be prepared from the method of curing the waterborne coating described herein. The waterborne coating may comprise (a) at least one photoinitiator and (b) at least one pigment, wherein the pigment volume concentration of the waterborne coating is 2.0% to 68.7%. The waterborne coating may further comprise at least one thickener, defoamer, surfactant, dispersant, solvent, antimicrobial agent, pigment, matting agent. solvent, pH adjuster, hardener, resin, light stabilizer, plasticizer, antioxidant, or combinations thereof. Other materials are also contemplated.

In many embodiments, the waterborne coating prepared from the method of curing the waterborne coating described herein may have improved scratch resistance, hiding, adhesion, hardness, and gloss consistency. Further, the waterborne coating prepared from the method of curing the waterborne coating described herein may have a decreased VOC content. In many embodiments, the volatile organic compounds (VOC) according to 2010/75/EU of the coatings system are less than 100 g/1. In other embodiments, the volatile organic compounds (VOC) are less than 80 g/l, less than 75 g/l, less than 60 g/l, less than 50 g/l, less than 45 g/l, less than 40 g/l, less than 35 g/l, less than 30 g/l, less than 25 g/l, less than 20 g/l, less than 15 g/l, less than 10 g/l, less than 5 g/l, less than 3 g/l, or less than 2 g/l. Alternatively, the waterborne coating prepared from the method of curing the waterborne coating described herein may be measured by ASTM D3960 with similar results. In many embodiments, the volatile organic compounds (VOC) according to ASTM D3960 of the coatings system are less than 100 g/l. In other embodiments, the volatile organic compounds (VOC) are less than 80 g/l, less than 75 g/l, less than 60 g/l, less than 50 g/l, less than 45 g/l, less than 40 g/l, less than 35 g/l, less than 30 g/l, less than 25 g/l, less than 20 g/l, less than 15 g/l, less than 10 g/l, less than 5 g/l, less than 3 g/l, or less than 2 g/l.

In many embodiments, an article in which the waterborne coating described herein has been applied. The waterborne coating may comprise (a) at least one photoinitiator and (b) at least one pigment, wherein the pigment volume concentration of the waterborne coating is 2.0% to 68.7%. In many embodiments, the article comprises wood, metal, plastic, paper, leather, fabric, ceramic, concrete, composites, or combinations thereof.

### Test Results

The waterborne coating described herein prepared from the method of curing described may provide the following test data shown below in Table 1. Product A is a medium resistant pigmented WBUV topcoat commercially used in kitchen applications that has been cured by drying and UV, drying and UV with EB, and drying and UV with isocyanate pre-addition. Product B is a high resistant pigmented WBUV commercially used in kitchen application applications that has been cured by both drying and UV and drying and UV with EB. Product C is a high resistant pigmented WBUV topcoat commercially used in kitchen application formulated with same hiding power as Product A and cured by both drying and UV and drying and UV with EB. Various PVC's and curing methods were used for each Product. Initial pendulum hardness, scratch resistance, and alcohol resistance were all tested according to Pendulum damping test ISO 1522:2006, Resistance to scratch prEN 14354:2001, and Cold liquid resistance SS-EN 12720:2019, respectively. Color hiding was measured using a spectrophotometer (X-rite, Color i5) and applications on black and white cards from Leneta. For alcohol resistance (in Table 1 below as Alcohol 48% 1 day after curing), the rating scale is 1-5 with 1 being the worst. As provided in Table 1, Products in which both UV and EB curing are used may have improved properties for hardness, scratch resistance, and alcohol resistance.

TABLE 1

| | | | | | Initial | Initial | Alcohol 48% |
|---|---|---|---|---|---|---|---|
| | | Color | | | Pendulum | Scratch | 1 Day after |
| Product | PVC | hiding | Curing | Comment | Hardness | Resistance | Curing |
| A | 33 | 100% | Drying + UV | Post handling problems. | reference | reference | 2 |
| | | | | Limit to workable film forming | | | |
| | | | | temperature. | | | |
| | | | | Reduced Alcohol resistance due to low | | | |
| | | | | crosslinking | | | |
| | | | | Full color hiding with high pigmentation. | | | |
| | 33 | 100% | Drying + UV + EB | Better scratch and alcohol resistance | +42% | +27% | 3 |
| | | | | Harder | | | |
| | | | | than without EB | | | |
| | 33 | 100% | Drying + UV with | Softer | −26% | n.a. | 3 |
| | | | isocyanate pre- | Better alcohol resistance | | | |
| | | | addition | Pot-life | | | |
| B | 2.4 | 80% | Drying + UV | Good crosslinking | reference | reference | 4 |
| | | | | Less full color hiding | | | |
| | 2.4 | 80% | Drying + UV + EB | Similar properties as Formula B with | +6% | same as | 4 |
| | | | | only drying + UV | | reference | |
| C | 33 | 100% | Drying + UV | Full color hiding | reference | reference | 1 |
| | | | | Reduced alcohol resistance. | | | |
| | 33 | 100% | Drying + UV + EB | Harder | +81% | +220% | 4 |
| | | | | Full color hiding | | | |
| | | | | Improved scratch and alcohol resistance | | | |

### Embodiments

The following embodiments are contemplated. All combinations of features and embodiments are contemplated.

Embodiment 1: A method of curing a waterborne coating comprising: (1) preparing a waterborne coating comprising: (a) at least one photoinitiator and (b) at least one pigment, wherein the pigment volume concentration of the waterborne coating is 2.0% to 68.70%; (2) curing the waterborne coating using UV radiation; and (3) curing the waterborne coating using EB.

Embodiment 2: An embodiment of Embodiment 1, wherein the method of curing the waterborne coating of Claim 1, wherein at least one photoinitiator comprises a surface curing photoinitiator of type I, a type II photoinitiator, or combinations thereof.

Embodiment 3: An embodiment of any of Embodiments 1-2, wherein at least one pigment comprises an organic pigment, an inorganic oxide, or combinations thereof.

Embodiment 4: An embodiment of any of Embodiments 1-3, wherein the pigment volume concentration of the waterborne coating is 2.4% to 60.0%

Embodiment 5: An embodiment of any of Embodiments 1-3, wherein the pigment volume concentration of the waterborne coating is 3.0% to 55.0%.

Embodiment 6: An embodiment of any of Embodiments 1-5, further comprising the step of drying the waterborne coating prior to curing the waterborne coating using UV radiation.

Embodiment 7: An embodiment of Embodiment 6, wherein at least one heat source is used for drying the waterborne coating.

Embodiment 8: An embodiment of Embodiment 7, wherein drying the waterborne coating is performed at temperatures ranging from 10° C. to 95° C.

Embodiment 9: An embodiment of Embodiment 6, wherein infrared radiation is used for drying the waterborne coating.

Embodiment 10: An embodiment of Embodiment 9, wherein the infrared radiation is provided by at least one infrared radiation battery.

Embodiment 11: An embodiment of any of Embodiments 1-10, wherein the waterborne coating further comprises acrylate functional water dispersed binder, defoamer, matting agent, wetting agent, filler, or combinations thereof.

Embodiment 12: An embodiment of any of Embodiments 1-11, wherein at least one photoinitiator is used in curing the waterborne coating using UV radiation.

Embodiment 13: An embodiment of any of Embodiments 1-12, wherein nitrogen addition is minimized during the curing the waterborne coating using EB.

Embodiment 14: An embodiment of any of Embodiments 1-13, wherein the curing the waterborne coating using EB is performed at temperatures ranging from −10° C. to 50° C. and a relative humidity ranging from 2% to 85%.

Embodiment 15: A waterborne coating prepared from the method of Embodiments 1-14.

Embodiment 16: An article in which the waterborne coating of Embodiment 15 has been applied, wherein the article comprises wood, metal, plastic, paper, leather, fabric, ceramic, or combinations thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of curing a waterborne coating comprising:
preparing a waterborne coating comprising: (a) at least one photoinitiator and (b) at least one pigment, wherein the pigment volume concentration of the waterborne coating is 2.0% to 68.7%;
curing the waterborne coating using UV radiation; and
curing the waterborne coating using EB.

2. The method of curing the waterborne coating of claim 1, wherein at least one photoinitiator comprises a surface curing photoinitiator of type I, a type II photoinitiator, or combinations thereof.

3. The method of curing the waterborne coating of claim 1, wherein at least one pigment comprises an organic pigment, an inorganic oxide, or combinations thereof.

4. The method of curing the waterborne coating of claim 1, wherein the pigment volume concentration of the waterborne coating is 2.4% to 60.0%.

5. The method of curing the waterborne coating of claim 1, wherein the pigment volume concentration of the waterborne coating is 3.0% to 55.0%.

6. The method of curing the waterborne coating of claim 1, further comprising the step of drying the waterborne coating prior to curing the waterborne coating using UV radiation.

7. The method of curing the waterborne coating of claim 6, wherein at least one heat source is used for drying the waterborne coating.

8. The method of curing the waterborne coating of claim 7, wherein drying the waterborne coating is performed at temperatures ranging from 10° C. to 95° C.

9. The method of curing the waterborne coating of claim 6, wherein infrared radiation is used for drying the waterborne coating.

10. The method of curing the waterborne coating of claim 9, wherein the infrared radiation is provided by at least one infrared radiation battery.

11. The method of curing the waterborne coating of claim 1, wherein the waterborne coating further comprises acrylate functional water dispersed binder, defoamer, matting agent, wetting agent, filler, or combinations thereof.

12. The method of curing the waterborne coating of claim 1, wherein at least one photoinitiator is used in curing the waterborne coating using UV radiation.

13. The method of curing the waterborne coating of claim 1, wherein nitrogen addition is minimized during the curing the waterborne coating using EB.

14. The method of curing the waterborne coating of claim 1, wherein the curing the waterborne coating using EB is performed at temperatures ranging from −10° C. to 50° C. and a relative humidity ranging from 2% to 85%.

15. A waterborne coating prepared from the method of claim 1.

16. An article in which the waterborne coating of claim 15 has been applied, wherein the article comprises wood, metal, plastic, paper, leather, fabric, ceramic, or combinations thereof.
